(19) United States
(12) Patent Application Publication
(10) Pub. No.: US 2005/0052410 A1
(43) Pub. Date: Mar. 10, 2005

(54) Antimicrobial personal computer aggregation

(75) Inventor: Ga-Lane Chen, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/949,492

(22) Filed: Sep. 24, 2004

(30) Foreign Application Priority Data
Jul. 11, 2003 (TW) 92219771

(51) Int. Cl. G09G 5/00

(52) U.S. Cl. 345/156

(57) ABSTRACT

A personal computer suite (1) includes a computer (10), a monitor (20), a mouse (30), and a keyboard (40). The monitor, the keyboard and the mouse are electrically connected with the computer. The computer includes a plurality of manual switches (11) for respectively controlling a power source and various functions of the computer. The monitor has a display screen (21) for displaying images. The switches, the display screen, the mouse and the keyboard each include a photocatalyst layer portion at a surface thereof. The photocatalyst layer portion can react with water and oxygen molecules that are in contact with surfaces thereof to produce hydrogen ions, hydroxyl radicals and free oxygen radicals. Thus, sterilization of the personal computer suite is provided. In addition, the photocatalyst layer portions are super hydrophilic, which makes cleaning of the surfaces of the switches, the display screen, the mouse and the keyboard easy.

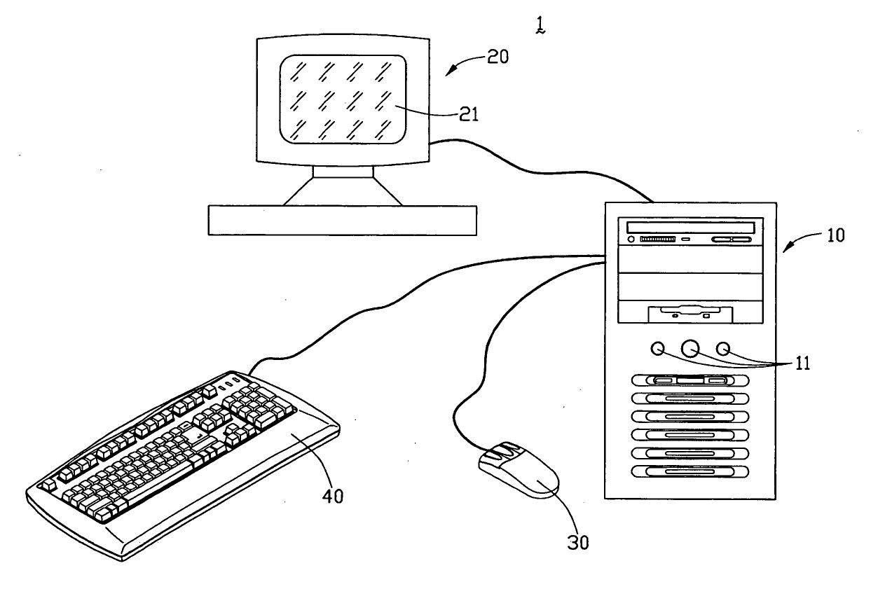

### TECHNICAL FIELD

The present invention relates to physical maintenance of personal computers and personal computer suites, and more particularly to various kinds of personal computer hardware and housings that are antimicrobial and easy to clean.

### BACKGROUND

Personal computers are becoming ever more important tools in peoples' daily work, study and living. Generally, a conventional desktop personal computer suite comprises a computer, a monitor, a mouse, and a keyboard, all of which are exposed to ambient air. Surfaces of the personal computer suite generally accumulate dirt and dust over time, and parts that are frequently touched by users are prone to develop various kinds of harmful bacteria and produce unpleasant smells. The personal computer suite may become unhygienic and a medium for spreading infectious diseases. Users may neglect to clean and sterilize the personal computer suite periodically. In addition, it can be difficult and laborious to completely clean and sterilize the personal computer suite.

A photocatalyst is a substance that facilitates chemical reactions when it is exposed to light, but without becoming transformed itself. Generally, photocatalysts are used for deodorizing, sterilizing, antibacterial applications, antifouling, and removal of toxic substances.

Titanium dioxide particles are one kind of typical photocatalyst. When the titanium dioxide particles are irradiated by ultraviolet rays with a wavelength less than 400 nanometers, electrons in the valence band of the titanium dioxide undergo a transition from the valence band to the conduction band due to absorption of the energy of the ultraviolet rays, and holes with positive charges are produced. Therefore, a plurality of electron-hole pairs is formed. The plurality of electrons and holes can react with water and oxygen molecules which contact surfaces of the titanium dioxide particles, to produce active free radicals such as free oxygen radicals, hydroxyl radicals, etc. The free radicals are very powerful oxidants.

The free radicals produced are capable of decomposing organic dust and grease into carbon dioxide (CO₂), water (H₂O), etc. Therefore, carbon atoms contained in organic substances at the surface of the titanium dioxide particles are stripped from the organic substances and oxidized, thereby decomposing the organic substances. This decomposition kills bacteria, removes bad smells, and prevents adhesion of dirt to a surface that needs to be maintained.

U.S. Pat. No. 6,462,947 discloses a computer enclosure that combines a photocatalyst and an ultraviolet light source as a means to purify air. The computer enclosure comprises: a metal wire gauze filter positioned in an air input port of a face panel; an induced draft fan positioned behind the metal wire gauze filter to draw outside air into the air input port toward an air output port at a rear side of the computer enclosure; and an ultraviolet lamp installed in the computer enclosure to emit light onto a titanium dioxide coating on the face panel, the wire gauze filter, and an inside wall of the computer enclosure in order to purify air passing through the air input port and the air output port.

However, the configuration of the computer enclosure can only purify soiled air passing through the air input port and the air output port. It cannot prevent the whole personal computer suite from accumulating dirt, developing harmful bacteria, and producing unpleasant smells.

Therefore, an entire personal computer suite which is antimicrobial and easy to clean is desired.

### SUMMARY OF THE INVENTION

Accordingly, an object of the present invention is to provide a personal computer aggregation which is antimicrobial and easy to clean.

In order to achieve the object set out above, a personal computer suite in accordance with an exemplary embodiment of the present invention comprises a computer, a monitor, a mouse and a keyboard. The monitor, the mouse and the keyboard are electrically connected with the computer. The computer comprises a plurality of switches for respectively controlling a power source and various functions of the computer. The monitor comprises a display screen for displaying images. The switches, the display screen, the mouse and the keyboard each comprise a photocatalyst layer portion at a surface thereof. A photocatalyst material of the photocatalyst layer portion can, when exposed to light, react with water molecules and oxygen molecules that are in contact with surfaces of the photocatalyst layer portion to produce hydrogen ions, hydroxyl radicals and free oxygen radicals. In one aspect, due to the free oxygen radicals having strong oxidizing and reduction abilities, harmful bacteria and stains cumulated on the switches, the display screen, the mouse and the keyboard are decomposed, and extraneous matter on which harmful bacteria could multiply is destroyed. Therefore, sterilization of the switches, the display screen, the mouse and the keyboard is provided.

In another aspect, the hydrogen ions and the hydroxyl radicals resist formation of drops of water on surfaces of the switches, the display screen, the mouse and the keyboard, because the hydrogen ions and the hydroxyl radicals reduce a contact angle of the water drops to a small contact angle. Thus the surfaces of the switches, the display screen, the mouse and the keyboard are super hydrophilic, which makes cleaning easy. In summary, the switches, the display screen, the mouse and the keyboard are portions of the personal computer suite which are most frequently contacted by users' hands, and are most prone to cumulating bacteria, dirt and contaminants. The photocatalyst layer portions render the switches, the display screen, the mouse and the keyboard antimicrobial and easy to clean.

Other objects, advantages and novel features of the present invention will become more apparent from the following detailed description when taken in conjunction with the accompanying drawing, in which:

### BRIEF DESCRIPTION OF THE DRAWING

The drawing is an isometric view of the personal computer suite according to the exemplary embodiment of the present invention.

### DETAILED DESCRIPTION OF PREFERRED EMBODIMENTS OF THE INVENTION

Referring to the drawing, a personal computer suite 1 according to the exemplary embodiment of the present invention comprises a computer 10, a monitor 20, a mouse 30 and a keyboard 40. The monitor 20, the mouse 30 and the keyboard 40 are each electrically connected with the computer 10. The computer 10 comprises a plurality of manual switches 11 for respectively controlling a power source (not shown) and various functions of the computer 10. The monitor 20 comprises a display screen 21 for displaying images. The switches 11, the display screen 21, the mouse 30 and the keyboard 40 each comprise a photocatalyst layer portion (not shown) at a surface thereof.

The photocatalyst layer portion is made of a photocatalyst material selected from the group consisting of titanium dioxide (TiO₂), zinc oxides (ZnO_{X}), and so on. The photocatalyst material has an average particle size in the range from 15 to 50 nanometers. In the exemplary embodiment, the photocatalyst layer portion is formed by sputtering, soaking, or coating surfaces of the switches 11, the display screen 21, the mouse 30 and the keyboard 40. Alternatively, the photocatalyst material can be added into raw materials used to make the switches 11, the display screen 21, the mouse 30 and the keyboard 40 by way of molding. After molding the switches 11, the display screen 21, the mouse 30 and the keyboard 40 from the duly modified raw materials, the photocatalyst material is distributed in the switches 11, display screen 21, mouse 30 and keyboard 40, thereby providing the needed photocatalyst layer portions thereof.

Each photocatalyst layer portion has a structure determined by its method of formation. When the photocatalyst layer portion is formed on the surfaces of the switches 11, the display screen 21, the mouse 30 and the keyboard 40 by way of sputtering, soaking or coating, the photocatalyst layer portion essentially has a two-dimensional structure. When the switches 11, the display screen 21, the mouse 30 and the keyboard 40 are made by way of a molding process to provide the photocatalyst layer portions, the photocatalyst material is distributed throughout the switches 11, the display screen 21, the mouse 30 and the keyboard 40, and each photocatalyst layer portion essentially has a three-dimensional structure.

In principle, when each photocatalyst layer portion is irradiated by light, especially by ultraviolet light with a wavelength of less than 400 nanometers, the photocatalyst material of the photocatalyst layer portion reacts with water molecules and oxygen molecules that are in contact with surfaces of the photocatalyst layer portion to produce hydrogen ions, hydroxyl radicals and free oxygen radicals.

In one aspect, due to the free oxygen radicals having strong oxidizing and reduction capabilities, harmful bacteria and stains cumulated on the switches 11, the display screen 21, the mouse 30 and the keyboard 40 are decomposed, and extraneous matter on which harmful bacteria could multiply is destroyed. Therefore, sterilization of the switches 11, the display screen 21, the mouse 30 and the keyboard 40 is provided. In another aspect, the hydrogen ions and the hydroxyl radicals resist formation of drops of water on surfaces of the switches 11, the display screen 21, the mouse 30 and the keyboard 40, because the hydrogen ions and the hydroxyl radicals reduce a contact angle of the water drops to a small contact angle. Thus the surfaces of the switches 11, the display screen 21, the mouse 30 and the keyboard 40 are super hydrophilic, which makes cleaning easy. In summary, the switches 11, the display screen 21, the mouse 30 and the keyboard 40 are portions of the personal computer suite 1 which are most frequently contacted by users' hands, and are most prone to cumulating bacteria, dirt and contaminants. The photocatalyst layer portions render the switches 11, the display screen 21, the mouse 30 and the keyboard 40 antimicrobial and easy to clean.

In addition, due to the strong oxidizing and absorption abilities of the photocatalyst layer, the photocatalyst layer helps remove various unpleasant smells that might otherwise build up over time. Thus, the personal computer suite 1 has the additional function of purifying ambient air.

The photocatalyst material of the photocatalyst layer portion can further comprise gold or platinum particles. This reduces the concentration of carbon monoxide gas in the ambient air. Preferably, the concentration of carbon monoxide gas is less than 30 ppm.

When the personal computer suite 1 is cleaned by hand, it should firstly be ensured that the switches 11, the display screen 21, the mouse 30 and the keyboard 40 are exposed to light in order to kill bacteria and remove stains. The light relied upon can be the light emitted by the monitor 20, sunlight, or light emitted from a lamp. Subsequently, the personal computer suite 1 can be cleansed by hand.

In alternative embodiments, the photocatalyst layer portion can be applied with respect to other kinds of personal computing devices such as notebooks, PDAs (Personal Digital Assistants), and portable communication devices. In the case of a notebook, the mouse is replaced by a touchscreen and/or a trackball, and the display screen, the keyboard and the touchscreen and/or trackball are integrated in a main body of the notebook.

It is to be further understood that the invention may be embodied in other forms without departing from the spirit thereof. Thus, the present examples and embodiments are to be considered in all respects as illustrative and not restrictive, and the invention is not to be limited to the details given herein.

1. A personal computer aggregation comprising:
a computer having a plurality of switches provided thereon;
a display device;
an inputting device; and
a keyboard,
wherein the display device, the inputting device and the keyboard are each electrically connected with the computer, and each of the switches, the display device, the inputting device and the keyboard has a photocatalyst layer portion at a surface thereof.

2. The personal computer aggregation in accordance with claim 1, wherein the photocatalyst layer portions are formed on surfaces of the switches, the display device, the inputting device and the keyboard.

3. The personal computer aggregation in accordance with claim 1, wherein the photocatalyst layer portion comprises a photocatalyst material selected from the group consisting of titanium dioxide and zinc oxides.

4. The personal computer aggregation in accordance with claim 3, wherein particles of the photocatalyst material have an average size in the range from 15 to 50 nanometers.

5. The personal computer aggregation in accordance with claim 1, wherein the photocatalyst layer portion comprises gold particles.

6. The personal computer aggregation in accordance with claim 1, wherein the photocatalyst layer portion comprises platinum particles.

7. The personal computer aggregation in accordance with claim 2, wherein the photocatalyst layer portions are formed by sputtering, soaking, or coating surfaces of the switches, the display device, the inputting device and the keyboard.

8. The personal computer aggregation in accordance with claim 3, wherein the switches, the display screen, the mouse and the keyboard are made by way of molding, and the photocatalyst material is distributed throughout the molded switches, display screen, inputting device and keyboard.

9. The personal computer aggregation in accordance with claim 1, wherein the inputting device is a computer mouse.

10. The personal computer aggregation in accordance with claim 1, wherein the keyboard is integrated with the computer.

11. The personal computer aggregation in accordance with claim 1, wherein the inputting device is a touchscreen and/or a trackball integrated with the computer.

12. The personal computer aggregation in accordance with claim 1, wherein the display device is integrated with the computer.

13. A method for making and using an antiseptic and easy-cleaning personal-computer related device, comprising the step of:
providing said usably personal-computer related device;
forming an exposed surface containing at least one photocatalyst layer outside said device; and
irradiating said exposed surface of said device with a ray of light having a predetermined wavelength so as to turn said exposed surface into an antiseptic and easy-cleaning status.

14. The method in accordance with claim 13, wherein said at least one photocatalyst layer is formed on said exposed surface by one of methods of sputtering, soaking, and coating.

15. The method in accordance with claim 13, wherein said at least one photocatalyst layer is formed in said exposed surface by integrally molding with said exposed surface.
